(19) United States
(12) Patent Application Publication
(10) Pub. No.: US 2003/0126068 A1
(43) Pub. Date: Jul. 3, 2003

(54) Virtual trading floor system

(76) Inventors: Eric Hauk, Barrington, IL (US); Michael Borchew, River Woods, IL (US)

Correspondence Address: Joseph H. Paquin, Jr., McDermott, Will & Emery, 227 West Monroe Street, Chicago, IL, 60606-5096, US

(21) Appl. No.: 10/324,507

(22) Filed: Dec. 20, 2002

Related U.S. Application Data
(63) Continuation of application No. 09/540,601, filed on Mar. 31, 2000.
(60) Provisional application No. 60/166,306, filed on Nov. 18, 1999.

(51) Int. Cl. G06F 17/60

(52) U.S. Cl. 705/37

(57) ABSTRACT

A virtual trading floor system for simulating the selling and buying in a financial market, auction forum or any market where buying and selling occurs is disclosed. The virtual trading floor system comprises a coder/decoder that receives data from a trading source such as data received from a central market place, such as the well-known NASDAQ, CBOT, CME, NYSE, EUREX markets, an exchange database or a website; a graphical interface that receives the data from the coder/decoder and displays a plurality of buying and selling trader metaphors representative of actual buying and selling traders; a control interface coupled to the coder/decoder for initiating orders, and a data interface coupled to the coder/decoder for displaying, receiving and transmitting data sent to and from the trading source.

### CROSS-RELATED REFERENCES

This application claims the benefit of U.S. Provisional Application No. 60/166,306 filed Nov. 18, 1999.

### FIELD OF THE INVENTION

The present invention is a virtual trading floor system. Particularly, the present invention is a virtual trading floor system that simulates in real-time the trading action of actual buying and selling traders in a financial market and graphically represents the buying and selling traders on a display.

### BACKGROUND OF THE INVENTION

Historically, trading has been conducted on exchange floor or auction forums, whereby numbers of active participants concurrently bid and offer for the right to buy or sell a particular stock or commodity. Gathered in a circle or trading pit, these traders compete against one another by attempting to buy from another trader in the trading pit at the lowest offered price and/or selling to another trader in the trading pit at the highest bid price. These traders gather in a common forum to buy and sell stocks and commodities throughout the trading session as the forces of supply and demand are influenced by current related news and events. Some traders go so far as to buy and sell the difference in price between like or different stocks and commodities in the same or different markets. This is a procedure known as arbitrage.

Recently, stock and commodity exchanges linked their auction market-activities to off-site locations to enable off-site traders to participate in the auction process from their homes or offices by calling in their orders to a broker. The broker relays the order to the exchange floor for execution and receives confirmation of the execution of that order from the exchange floor. The broker thereafter notifies the off-site trader that initiated the order of the execution price and quantity.

More recently, computer systems and networks have begun replacing the actual exchanges or trading floors, and now provide a live auction market for stocks and commodities that serves at present hundreds of active participants who monitor price changes in stocks and commodities on their computers and react by executing orders via their computer at their off-site location. This entire process is done Via computer, without an intermediary broker, communicating with servers that utilize an application programmer interface (API) to recognize the off-site trader. Data is communicated to the off-site trader and can be displayed on a computer monitor to be viewed by the participating off-site trader. The off-site trader can observe prices of stocks or commodities as they move up or down. The computer monitor can display prices live or on a 10 or 15 minute delay. Typically, a charting service is utilized to assist in the decision making process of the off-site trader. The off-site trader is provided with the current bid and offer of a specific stock or commodity and the trading sessions' highest and lowest prices, as well as other information. Oftentimes the previous day's closing price is displayed as well. By observing the prices of different stocks and commodities as displayed on a computer monitor in a spreadsheet or the like, off-site traders can actively participate in the market activity via a remote computer or terminal from virtually anywhere.

Due to the aforementioned advances in trading technology and the corresponding proliferation of off-site trading, it would be useful for traders to have a trading system that emulates trading floor action. Graphical representations of real or imagined environments on a two dimensional monitor, such as that of a computer, is one way to simulate action. Virtual reality takes such simulation further. Virtual reality is the simulation of a real or imagined environment that can be experienced visually in the three dimensions of width, height, and depth and that may additionally provide an interactive experience visually in full real-time motion with sound and possibly with tangible, perceptible feedback. A simple form of virtual reality is a 3-D image that can be explored interactively at a personal computer, usually by manipulating keys or the mouse so that the content of the image moves in some direction or zooms in or out. As the images become larger and interactive controls more complex, the perception of “reality” increases. More sophisticated efforts involve such approaches as wrap-around display screens, actual rooms augmented with wearable computers, and haptic joystick devices that let you feel the display images. Virtual reality can be used for the simulation of real environments such as the interior of a building or an airplane often with the purpose of training or education, or the development of an imagined environment, typically for a game or educational adventure. Virtual reality simulations may include graphical metaphors that represent a real person in a cyberspace system. These graphical metaphors are sometimes referred to as “avatars.” Upon entering such a system, a off-site trader can be defined by or can choose from a number of avatars. Sophisticated 3D avatars even change shape depending on what they are doing (e.g., walking, sitting, etc.).

There are known virtual reality generators for use with financial information. In U.S. Pat. No. 5,774,878 to Marshall, a virtual reality technique to allow money managers and financial analysts to easily view otherwise unmanageable amounts of complex information and in particular, financial information about financial markets such as information about equities, commodities, currencies, derivatives and their related markets is disclosed. The virtual reality world created by Marshall, however, does not map real world objects. Rather, the information displayed in the virtual reality world created by Marshall is abstract information about the real world that does not have a physical object equivalent in the real world.

There are also known automated securities. trading systems. U.S. Pat. No. 4,674,044 to Kalmus et al. discloses a specific, illustrative data processing based apparatus which makes an automated trading market for one or more securities. The system retrieves the best obtaining bid and asked prices from a remote data base covering the ensemble of institutions or others making a market for the relevant securities. Data characterizing each security buy/sell order requested by a customer is supplied to the system. The order is qualified for execution by comparing its specific content fields with predetermined stored parameters. The stored parameters may include the operative bid and asked current market prices, the amount of stock available for customer purchase or sale as appropriate, and the maximum acceptable single order size. Once qualified, the order is executed and the appropriate stored parameters are updated. The system provides inventory (position) control and profit accounting for the market maker. Finally, the system reports the executed trade details to the customer, and to national stock price reporting systems. Upon a change in the quoted price for a security, the system updates all relevant order qualification parameters. Kalmus et al. does not disclose a system that simulates in real-time the buying and selling actions of traders.

Accordingly, there is a need in the art for a real-time, virtual trading floor system that emulates the buying and selling actions of traders in financial markets. For novice traders, a system that emulates live trading floor or auction forum action will provide greater understanding of the trading system and will allow those traders to compete more effectively than if they had to rely on a spreadsheet or the like to view their financial information. For veteran traders, an off-site system that emulates a trading floor may revive the excitement and enthusiasm that was once experienced.

In the field of off-site trading, there is a particular need for a system that is easy to use and that allows off-site traders to experience the same visuals and audio sensations that live traders do to make the off-site traders more effective. There is also a need for a virtual trading system that generates metaphors or representations that mimic the actions of the open outcry markets on a computer screen, projection screen or in a virtual reality system requiring virtual reality goggles or a virtual reality headset and the like.

### SUMMARY OF THE INVENTION

The present invention is a virtual trading floor based on the pit traded open outcry auction process currently conducted at the major U.S. commodity and stock option exchanges. It is an object of the present invention to provide a front-end virtual trading floor system to be interconnected with existing electronic exchanges. It is further an object of the present invention to provide a system where traders from anywhere in the world may be linked to an exchange and where such traders are represented graphically as virtual pit participants.

It is further an object of the present invention to provide a virtual trading system where individual traders may participate via live, real-time feeds. In such a system, an off-site trader using a personal computer system can view a virtual trading floor on the computer's monitor. The display may be a 2-dimensional or 3-dimensional display that may or may not require special viewing equipment. The virtual trading floor will comprise metaphors of actual buying and selling traders trading on the current exchange. The virtual trading floor, using the metaphor, will mimic the pit traded open outcry auction process. Using the virtual trading floor as a guide, individual traders can submit orders and interact with a market or a plurality of markets through an integrated order entry system that will rout the order to the exchange floor or trading source. The order entry screen will display typical data utilized by traders including bid, offer, size, and last price information relating to a particular stock or commodity.

It is a further object of the invention to provide a virtual reality trading system. In an embodiment, an off-site trader will conduct trades as a participant in a virtual pit, as opposed to the virtual trading floor where the trader views a 2 or 3 dimensional display. In the virtual reality trading system, an interface may be used to generate a virtual reality simulation that includes full-motion graphical metaphors that represent actual persons in a cyberspace system. Such an interface would be capable of generating 3-dimensional metaphors whose movements, actions, size and shape are responsive to and synchronized with an actual trader's movements. It is contemplated that the virtual reality trading system could be implemented by way of 3-D generated virtual reality images, virtual reality headsets or goggles, virtual reality gloves, or more sophisticated approaches such as wrap-around display screens, actual rooms augmented with wearable computers, and haptic joystick devices that allow a user to feel the display images, or any other virtual reality systems or equipment.

It is a further object of the present invention to provide a trading game utilizing either the virtual trading or virtual reality trading systems. In the trading game embodiment, single players and/or multiple players connected locally or remotely over a network, including the packet-switched network known as the Internet, can compete with or trade with either computer-created metaphors, or with other players where each player is represented by a metaphor.

It is a further object of the present invention to provide a training simulator utilizing either the virtual trading or virtual reality trading systems. In the training simulator embodiment, single trainees and/or multiple trainees connected locally or remotely over a network can be trained using either computer-created metaphors, or with other trainees where each trainee is represented by a metaphor.

To accomplish these and other objects, in one aspect, the present invention comprises a coder/decoder that receives and transmits data; a graphic interface coupled to the coder/decoder that receives and displays certain of the data transmitted from the coder/decoder as a plurality of buying and selling trader metaphors representative of actual buying and selling traders; a control interface coupled to the coder/decoder for initiating orders related to the data received and transmitted by the coder/decoder; and a data interface coupled to the coder/decoder for displaying the data in a non-graphic, human-readable form, and for receiving and transmitting data to and from the coder/decoder.

In another feature, the present invention comprises a source that generates data, and a graphical interface that receives the data from the source and displays a plurality of buying and selling trader metaphors representative of actual buying and selling traders.

In another feature, the present invention comprises a coder/decoder that receives data; a graphical interface coupled to the coder/decoder that receives the data from the coder/decoder and displays a plurality of buying and selling trader metaphors representative of actual buying and selling traders.

In another feature, the present invention comprises a coder/decoder that receives data;

a control interface coupled to the coder/decoder; a data interface coupled to the coder/decoder; and a graphical interface coupled to the coder/decoder for receiving the data from the coder/decoder and for displaying a plurality of buying and selling trader metaphors representative of actual buying and selling traders, wherein the movement of at least one of the buying and selling metaphors is responsive to and synchronized with a trader's movements.

In another feature, the present invention comprises a trading simulator that comprises a source that generates data; a coder/decoder coupled to the source; a control interface coupled to the coder/decoder; a data interface coupled to the coder/decoder; and a graphical interface coupled to the coder/decoder for displaying a plurality of buying and selling trader metaphors representative of actual buying and selling traders, wherein the movement of at least one of the buying and selling metaphors is responsive to and synchronized with a trader's movements.

In another feature, the present invention comprises a method of trading using a virtual trading simulator, comprising the steps of generating data; receiving and interpreting the data; displaying the data in the form of a plurality of buying and selling trader metaphors representative of buying and selling traders.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of the virtual trading floor system according to the invention, comprising a coder/decoder, avatar interface, data interface and a control interface;

FIG. 2 is a graphic of the metaphors used to represent buying and selling traders generated by the avatar interface of FIG. 1 according to the invention;

FIG. 3 is a graphic showing a larger number of buying trader metaphors than selling trader metaphors as might result in a bullish environment for a particular stock or commodity;

FIG. 4 is a graphic showing a virtual trading floor, quote board, order input entry bar and graphs as may be viewed on a display at the option of a trader, and as generated by the avatar, data and control interfaces of FIG. 1 according to the invention;

FIG. 5 is a graphic showing multiple virtual trading floors representing multiple markets as may be viewed at the option of a trader;

FIG. 6 is an illustration showing an alternative embodiment of the display of FIG. 4, comprised of an order entry input screen on one monitor and a quote board and a virtual trading floor on a second monitor;

FIG. 7 is an illustration of a trader's current position screen according to an embodiment the invention;

FIG. 8 is a graphic illustrating a virtual reality trading floor according to an alternative embodiment of the invention; and

FIG. 9 is a block diagram that illustrates a computer system which may comprise any one or more of the trading source, coder/decoder, avatar interface, data interface or control interface.

### DETAILED DESCRIPTION OF THE PREFERRED EMBODIMENT

A method and system for a virtual trading floor is described. In the following description, for the purposes of explanation, numerous specific details are set forth in order to provide a thorough understanding of the present invention. It will be apparent, however, to one skilled in the art that the present invention-may be practiced without these specific details. In other instances, well-known structures and devices are shown in block diagram form in order to avoid unnecessarily obscuring the present invention.

Virtual Trading Floor System

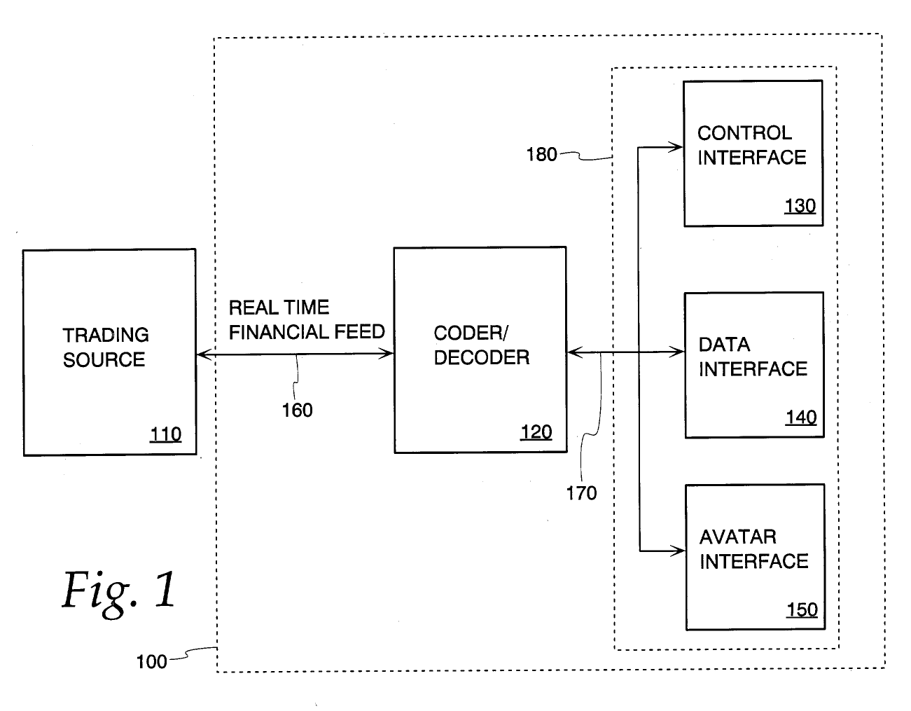

Referring to FIG. 1, a virtual trading floor system 100 is coupled to a trading source 110 that generates financial data. In an embodiment, the virtual trading floor system 100 comprises a coder decoder 120, a control interface 130, a data interface 140 and a graphic or avatar interface 150. The coder/decoder 120 is coupled by line 160 to the trading source 110. The avatar interface 150 is coupled by line 170 to the coder/decoder 120. The control 130 and data 140 interfaces are also coupled by line 170 to the coder/decoder 120. In an embodiment, a computer system 180 to be utilized by an off-site trader encompasses the avatar interface 150, the control interface 130 and the data interface 140. It is not critical to the present invention that a trader, and thus the computer system 180, be off-site in respect to the trading source 110. For example, when the virtual trading floor system 100 is used in the gaming and training environments discussed further herein, the trader may be located at the trading source 110 or the location where the financial data is generated. Also, in an embodiment, the trading source 110 may be any computer system or computer network that generates real-time, data received from a central market place, such as the well-known NASDAQ, CBOT, CME, NYSE, EUREX markets, any other primary or secondary marketplace, any private auction network or auction web site, or any forum where buying and selling takes place. Line 160 and line 170 may comprise one or more types of transmission media including coaxial cables, copper wire and fiber optics that use electrical, electromagnetic, optical or any type of medium and signal capable of carrying analog and digital data streams. Wireless links may also be implemented.

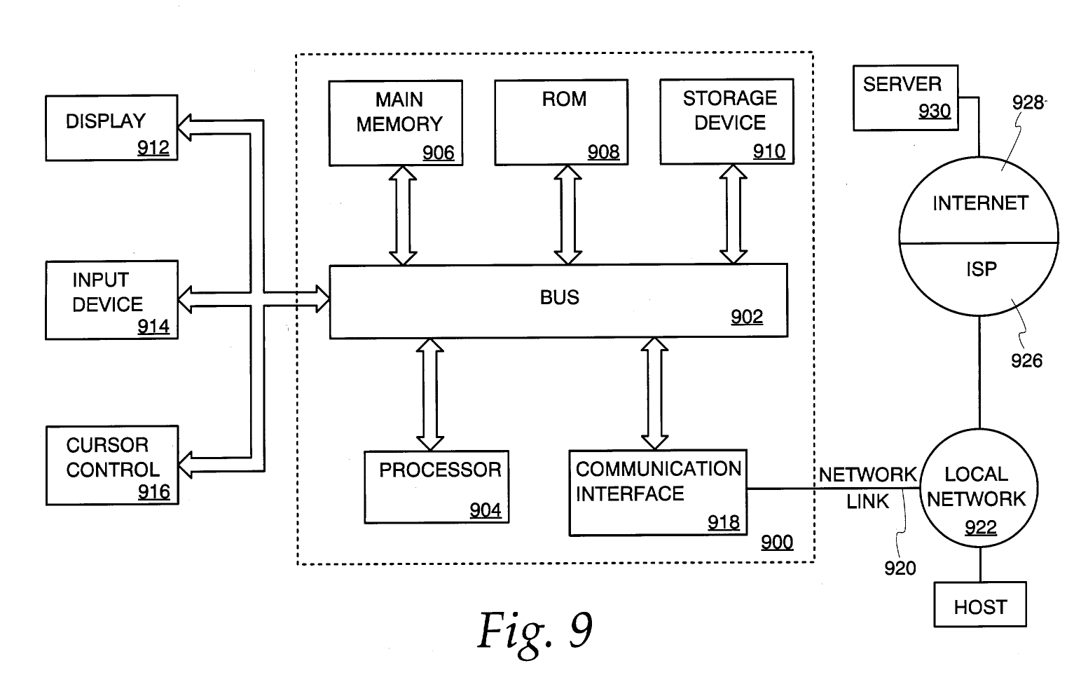

As shown in FIG. 1, the control interface 130, data interface 140 and avatar interface 150 are coupled via line 170 and may communicate data and commands freely between one another as required. In general, the avatar interface 150 serves as an interface for viewing financial data transmitted from trading source 110 in graphic and/or audio form. The control interface 130 serves as an interface from which a trader can initiate orders and order related information. The data interface 140 serves as an interface for displaying quote boards, as are generally known the art, and for transmitting orders and order related information, initiated and generated at the control interface 130, to the trading source 110. The data interface 140 also receives confirmation of orders along with other data from trading source 110. The control interface 130, avatar interface 150, and data interface 140 may each comprise software and/or hardware. In one embodiment, the hardware may be in the form of a computer system having an associated display as shown in more detail in FIG. 9. The control interface 130, avatar interface 150, and data interface 140 may also comprise a single interface, or any two of the interfaces may be combined to comprise a single interface.

The coder/decoder 120 of FIG. 1 is of a kind that encodes and decodes various types of data—particularly data that would otherwise use up inordinate amounts of disk space such as that to be generated by the trading source 110. The coder/decoder 120 can be used with either streaming data or files-based content. The decoder translates encoded data, such as compressed, real-time data that may be received from the trading source 110, into its original format or any other useable format.

The coder/decoder 120 may also comprise multiplexing and de-multiplexing circuitry. In an embodiment, multiplexing circuitry may be used to combine trading source 110 information received from several trading sources or exchanges. Also, in an embodiment, the demultiplexor circuitry will separate multiplexed signals from the trading source 110. This signals can then be processed by the coder/decoder 120 and sent using an appropriate protocol to the avatar interface 150, the data interface 140 and the control interface 130.

The coder/decoder 120 may also comprise a modem that can communicate data over a conventional telephone line to remote devices such as the trading source 110 or the computer system 180. A modem is merely one example of a device suitable for use as a communication means. Alternatively, the communication means of the coder/decoder 120 may be an infrared communications device, an Ethernet interface, an ISDN terminal adapter, or another telecommunications device. The specific communication method, protocol or mode used by the coder/decoder 120 is not critical. The same holds true regarding communication to and from the trading source 110, avatar interface 150, data interface 140 and control interface 130. Also, while the coder/decoder 120, avatar interface 150, data interface 140 and control interface 130 are shown as stand-alone devices, they could also be part of one or more integrated circuits that reside at the trading source 110 location or at computer system 180.

In an embodiment, the coder/decoder 120 receives digital data streams from the trading source 110 comprising discrete packets of information. The packets may contain bid, offer and confirmed transaction results, in addition to other financial data provided by the trading source 120. Or the packets may contain data from an auction forum whose data is accessible from a web site or private network. In such a case, the coder/decoder 120 may comprise software such as a web browsing application to acquire the necessary data. Having software algorithms that are responsive to predetermined data patterns and formats, the coder/decoder 120 decodes and processes data received from the trading source 110 and transmits the data to the avatar interface 150. The coder/decoder 120 will in turn send packets of data to the computer system 180, in audio, video, graphic, text and/or numeric form. In an embodiment, the coder/decoder 120 is a single unit device. In alternative embodiments, the coder/decoder 120 may consist of a separate coder and decoder. Also, the software elements of the coder/decoder 120 may be implemented in the form of firmware or hardwired circuitry that carries out the functions described herein. Implementation in software in this arrangement therefore is not required. For example, the decoding function may be accomplished using a decoder card.

In an embodiment, real-time data received from a stock or commodity market is interfaced to the virtual trading floor system 100 via the coder/decoder 120. For definitional purposes, a commodity is identified here as any product that can be bought or sold through an auction process. Also, the terms financial data, data, stock, commodity and security, and each of their plural forms, shall each be defined as including the other terms. Live real time encoded financial data from the trading source 110, including bids and offers and the resulting confirmed transactions, are transmitted to the computer system 180 via the coder/decoder 120. Information from the trading source 110 is first transmitted to the coder/decoder 120 which decodes the received data. The received encoded data is thereafter interpreted, processed and transmitted to the computer system 180. The data from the trading source 110 is displayed at the computer system 180 in graphic and non-graphic form. Relying on the displayed data, a trader may use computer system 180 to initiate, trades, queries and requests.

The coder/decoder 120 decodes and demultiplexes the data stream received from the trading source 110 and interprets and processes the data in the various channels of the data stream. Software, and or hardware, at the coder/decoder 120 utilizes predefined algorithms that enables the coder/decoder 120 to process the real-time data feed from the trading source 110. In an alternative embodiment, the coder/decoder 120 can be a device that comprises a web browser or similar software that retrieves financial or other data, such as auction site data, from web sites or other networks.

Bid and offer information from traders and confirmed transaction information sent from the trading source 110 and detected at the coder/decoder 120, along with other data, are transmitted in accordance with predefined algorithms to the avatar interface 150. The avatar interface 150 may be any interface capable of generating real-time graphic representations of actual buying and selling traders, whether the buying or selling traders are operating in a real environment such as a stock or commodities market or in a game or training environment. In an embodiment, the avatar interface 150 may generate 2 or 3 dimensional displays that mimic open-market outcry auctions on a computer monitor, television, projection screen, virtual reality display or any other type of display. In an embodiment, the coder/decoder algorithms interpret, process and transmit the data from the trading source 110 in a form that allows the avatar interface 150 to generate a display of human metaphors that represent actual buying and selling traders.

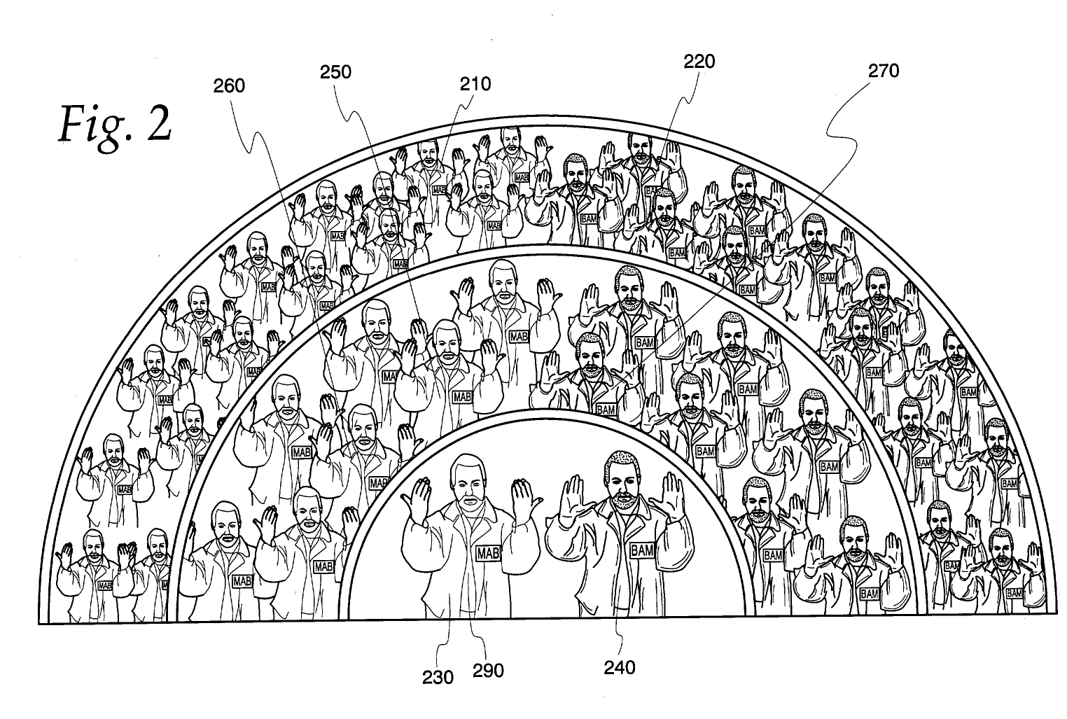

FIG. 2 is a graphic of the metaphors used to represent buying and selling traders in the virtual trading floor system 100 as generated by the avatar interface 150. Buying 210 and selling 220 trader metaphors represent participants in a real or imagined environment, such as a financial market, gaming or training environment. While the buying 210 and selling 200 trader metaphors are shown as human figures, any type of metaphor representative of actual buying and selling traders may be used.

The buying 210 and selling trader metaphors 220 generated by the avatar interface 150 appear as human figures dressed in trading jackets. In an embodiment, the buying 210 and selling trader metaphors 220 may appear in two or three dimensions on a monitor, or may appear in a virtual reality setting. The selling trader metaphors 220 appear with arms up and hands showing out, palms out away from the body. The buying trader metaphors 210 appear with hands up and facing in, towards the body, representing a desire to buy. Accordingly, the computer system's 180 display simulates an open auction trading pit with trader metaphors having the best bid and the best offer for a particular stock or commodity appearing in the forefront. The intent of the graphics is to give the most realistic view of a real auction or open outcry market, similar to real exchanges or auctions currently in use. From computer system 180, a trader can view the same prompt flow of data to a computer screen that would be seen without the graphics, and in addition by utilizing the computer system 180, a trader 180 can be an actual participant in a simulated live auction market process.

In an embodiment, the buying 210 and selling trader metaphors 220 will appear on a display of computer system 180 as life-like metaphors to mimic the appearance of traders on an exchange floor participating in an open outcry auction market. In an embodiment, the buying trader metaphors 210 are represented in green trading jackets. The actual trader having the best bid would be represented by the buying trader metaphor 230 in the front row. This way, a trader utilizing computer system 180 will be able to promptly recognize which trader has the best bid. Immediately behind buying trader metaphor 230 is buying trader metaphor 250 representing the second best bid. Next to buying trader metaphor 250 would be buying trader metaphor 260 representing the third best bid, and so on. Other trader metaphors are displayed immediately behind the best bid trader, buying trader metaphor 230 in this case, and fan out behind buying trader metaphor 230 in a descending order that represents the depth of the bids in that particular market.

Correspondingly, standing next to the buying trader metaphor 230, representing the best bid, is selling trader metaphor 240 representing the best offer by an actual trader for that particular market. The next best offers would be represented the same way as the bid traders, which is, immediately behind and fanning out and above selling trader metaphor 240. In an embodiment, all of the offering or selling traders are represented in red trading jackets. Other trader offers, beginning with selling trader metaphor 270 representing the next best offer, are displayed immediately behind selling trader metaphor 240 and fan out behind selling trader metaphor 240 in ascending order, thereby representing the depth of the offers in that particular market.

Consequently, the buying and selling traders viewed on a display by a trader at computer system 180 will appear as two side by side wedges, one wedge defined by buying trader metaphors 210 and the other wedge defined by selling trader metaphors 220, from which the trader can easily determine, and make judgments about, the best bid and best offer in a particular market. The trader can also easily make determinations about the depth of the buying and selling markets and can easily compare the buying and selling markets. Also, the trader can easily determine and compare other bids and offers in a market by virtue of the traders being stacked behind the best bid and best offer trader metaphors in descending and ascending order, respectively.

The price and quantity associated with each actual trader may be displayed on the respective chests 290 of the metaphors. These prices and quantities will represent the price and the number of contracts bid for or offered at a particular price. The price and quantities are those currently available from the exchange or trading source 110 feeding the data by way of the coder/decoder 120 to the computer system 180. The price and quantities can also, at a trader's discretion, be made known verbally by the trader metaphors. In one embodiment, the trader metaphors could speak the prices and quantities in response to a trader moving across a display of computer system 180, and ultimately across the desired trader metaphor, with a cursor or simply touching the screen in a touch-screen implementation. As market interaction occurs, and selling and buying among actual traders takes place, and prices change, a first trader metaphor may gesture and verbalize to an opposing trader metaphor any actions taken by that trader, such as might occur in an actual trading floor exchange.

Additionally, a trader at computer system 180 can determine the desired level of visual and audio activity via the avatar interface 150. The avatar interface 150 provides a multimedia representation of the real time data interpreted and processed by the coder/decoder 120. Associated audio data provided from the coder/decoder 120 can be programmed at the avatar interface 150 to increase as market activity increases, or a trader at computer system 180 can select to have the audio at a steady, constant level or to not have any accompanying audio at all. Audio quality can range from basic single channel audio to high fidelity stereo. Audio quality, however, is not critical. The avatar interface 150 will also allow a trader at computer system 180 to provide for more trader metaphors on the monitor as activity, including but not limited to trading volume and volatility, on either side of the market increases. Or, as market activity lessens, the noise level will diminish and less traders will appear on the screen. A trader at computer system 180 can opt to choose the audio, the visual, or both options to symbolize the current market activity.

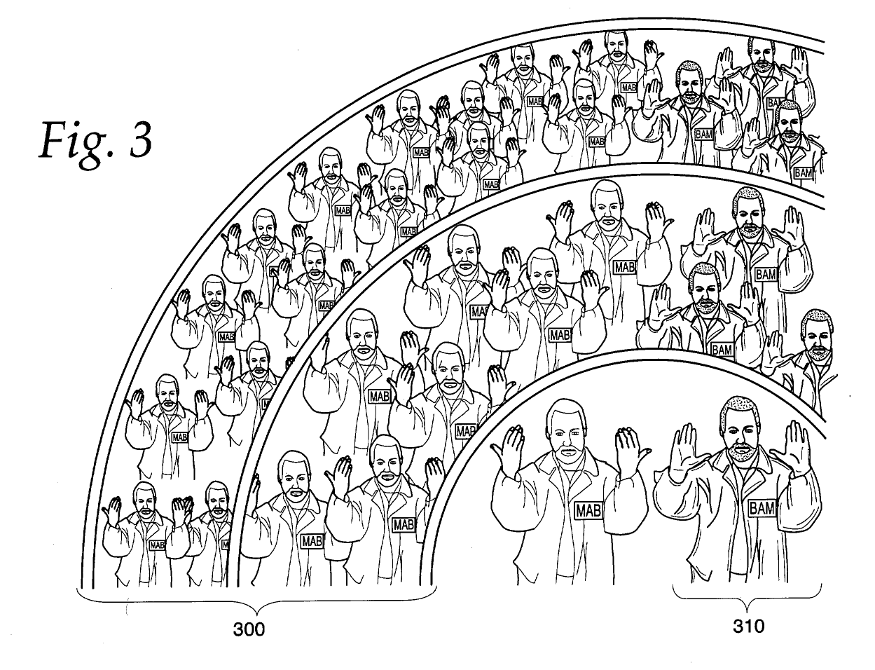

FIG. 3 is a graphic showing a larger number of buying trader metaphors than selling trader metaphors as might result in a bullish environment for a particular stock or commodity. During such bullish periods, the display at computer system 180 will display a large number of buying trader metaphors 300 wearing green jackets, as the trading volume increases. This would graphically and visually represent a large increase in buying volume and increased volatility as prices rise higher. Conversely, a lesser amount of red-jacketed selling trader metaphors 310 would appear, representing the sell depth of the market as much smaller than the buying depth.

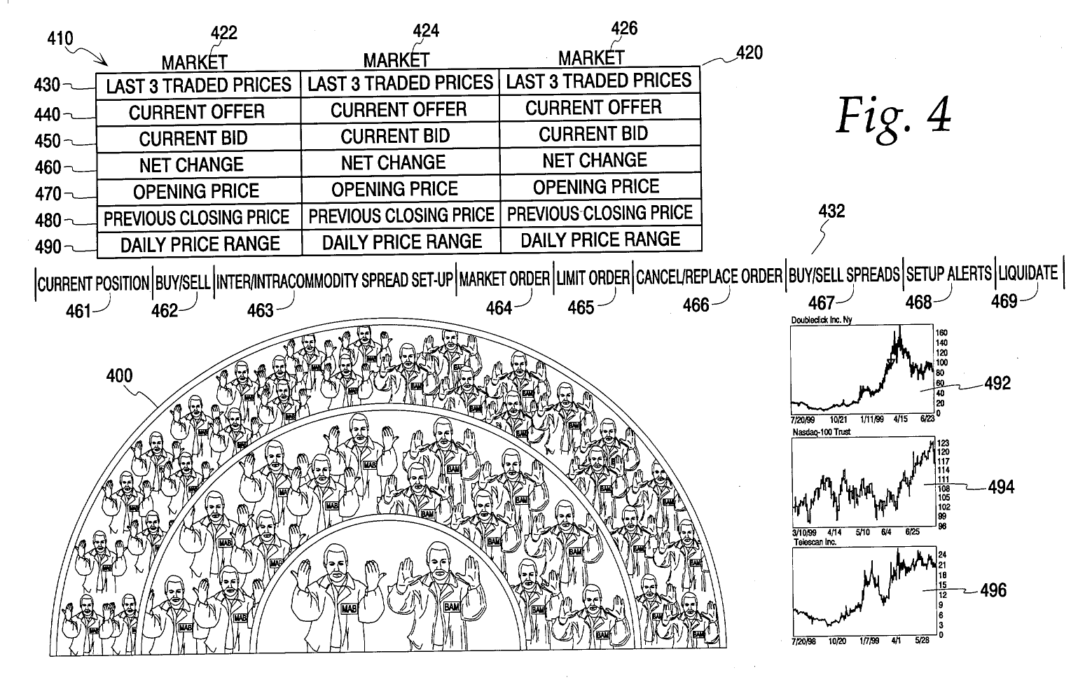

FIG. 4 is a graphic showing a virtual trading floor 400, quote board 420, order input entry bar 432 and graphs 492-496 as may be viewed on a single display 410 of computer system 180. In an embodiment, the virtual trading floor 400 is generated by the avatar interface 150, the quote board and graphs are generated by the data interface 140 and the order input entry bar 432 is generated by the control interface 130. Of course, the avatar interface 150, control interface 130 and data interface 140 could each be modified to generate any one or more of the virtual trading floor 400, quote board 420, order input entry bar 432 and graphs 492-496. To view current and past price information on both the active market simulated on the virtual trading floor 400 and other markets, a trader at computer system 180 may also choose to see the quote board 420 displayed over the virtual trading floor 400. The display 410 at computer system 180 may at a trader's discretion provide information for a plurality of markets as shown in the respective columns for market 422, market 424 and market 426. Each market 422-426 may include the following information: the last three traded prices in order of execution 430, the current offer 440, the current bid 450, net change for the day 460, opening price 470, previous day's closing price 480 and daily price range 490.

An order input entry bar 432, may also appear on the display 410 from which a trader may initiate orders. In an embodiment, the order entry input bar 432 is generated by the control interface 130. The order input entry bar 432 provides numerous options the trader may take to participate in the active market, including but not limited to the following selections: current position 461, buy/sell 462, inter/intracommodity spread setup 463, market order 464, limit order 465, cancel/replace order 466, buy sell/spreads 467, setup alerts 468 and liquidate 469, all of which are well-known, common selections that current traders use on existing stock and commodities trading systems in one form or another. For example, using the buy/sell 462 option, the trader can enter an instruction to buy or sell at specific price. Also for example, using the market order 464 option, the trader can enter an instruction to buy or sell at the available market price. The quantity to be transacted would also be indicated by the trader. The trader could also use the cancel/replace order 466 option to cancel all orders or the liquidate option 469 to liquidate all outstanding positions.

Graphs 492, 494 and 496 may reflect volume (y-axis) over time (x-axis) in the respective markets 422-426 and may be optionally viewed. The type of graphs provided are not critical, and may present market information in any form useful to a trader. In an alternative embodiment, individual display monitors may be used with computer system 180 to view the simulated virtual trading floor 400, quote board 410 and or graphs 492-496.

In an embodiment, the column of a specific market on the quote board 420 could be highlighted in a first predetermined color, upon selection by a trader, to indicate that the corresponding market is the market being simulated on the virtual trading floor 400. A column may also be highlighted in a second predetermined color to indicate that the corresponding market is the active market in which orders may be made via the order input entry bar 432.

As shown in FIG. 4, the column of market 422 may be highlighted in a predetermined color 421, such as yellow, to indicate that market 422 is the simulated market on the virtual trading floor 400. If the column for market 422 is the only highlighted column, then market 422 would also be the active market in which orders may be made via the order input entry bar 432.

In FIG. 4, however, the column of market 426 is also highlighted in a predetermined color 425, such as orange, to potentially indicate that the corresponding market 426 is the active market in which orders may be made via the order input entry bar 432. In that case, market 422 would remain as the market being simulated on the virtual trading floor 400.

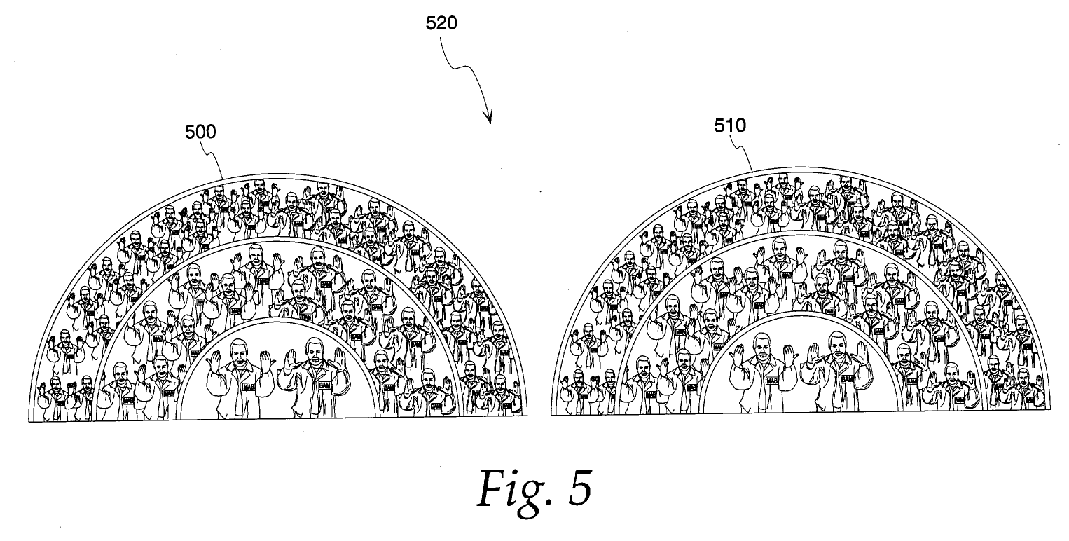

Referring to FIG. 5, in an embodiment, a trader at computer system 180 can simultaneously view multiple markets on a single display 520. The markets are represented by virtual trading floors 500 and 510. By selecting the desired markets, virtual trading floors for those markets will appear on the trader's display alongside one another as split images. This will enable the trader to easily view and trade price differentials within select stocks or commodities, or between different stocks or commodities.

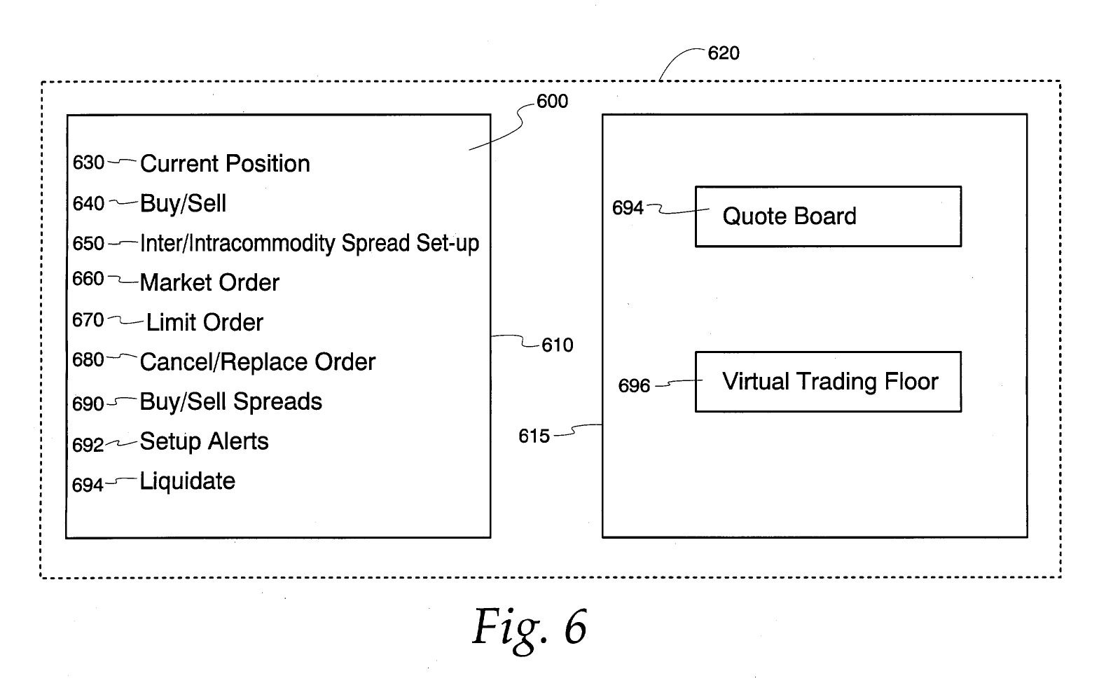

FIG. 6 is an illustration of a display 620 of computer system 180 according to an alternative embodiment. The display 620 is comprised of an order entry input screen 600 on one monitor 610, and a quote board 694 and a virtual trading floor 696 depicted on a second monitor 615. In this embodiment, the order entry input screen 600 is displayed on and generated by the control interface 130. Also in this embodiment, the virtual trading floor 694 is generated by the avatar interface 150 and the quote board 694 is generated by the data interface 140. The order input entry screen 600 has entries identical to those described in the order input entry bar 432 of FIG. 4, which include but are not limited to the following options: current position 630, buy/sell 640, inter/intracommodity spread setup 650, market order 660, limit order 670, cancel/replace order 680, buy sell/spreads 690, setup alerts 692 and liquidate 694. The quote board 694 and virtual trading floor 696 would also be similar to the quote board 420 and virtual trading floor 400 of FIG. 4.

Using the order input entry screen 600, a trader at computer system 180 may activate a specific option to perform trading functions within the same commodity or stock or among different commodities or stocks. The trader must activate the market for which the trader currently wishes to execute a trade on and that market will be displayed and highlighted on the quote board 694 and simulated on the virtual trading floor 696. Although all multiple markets may be viewed on the quote board 694 and the virtual trading floor 696, only a specific selected market or option will be active such that the trader may interact and place orders.

The commands resulting from the order entry input screen 600 options are directed from the data interface 140 to the coder/decoder 120, and will relate to the active market and the selected commodity, stock or option in that market. The order entry input screen 600 options can be selected in a number of different ways. In an embodiment, an option may be selected by scrolling up/down the options and typing in, for instance, the desired price and quantity to be traded relating to a particular security. The direction of the order, whether it is a buy or sell, would also be entered. In alternative embodiments, these options can also be selected by touching the order entry input screen 600 display or by other means including but not limited to selection via a mouse, a keyboard, a virtual reality glove or mitt, voice activation or a control console. As orders are made, the instructions of the trader will be sent immediately to the central marketplace by way of the data interface 140 through the coder/decoder to the trading source 110. A verification response will be sent to confirm receipt of the order.

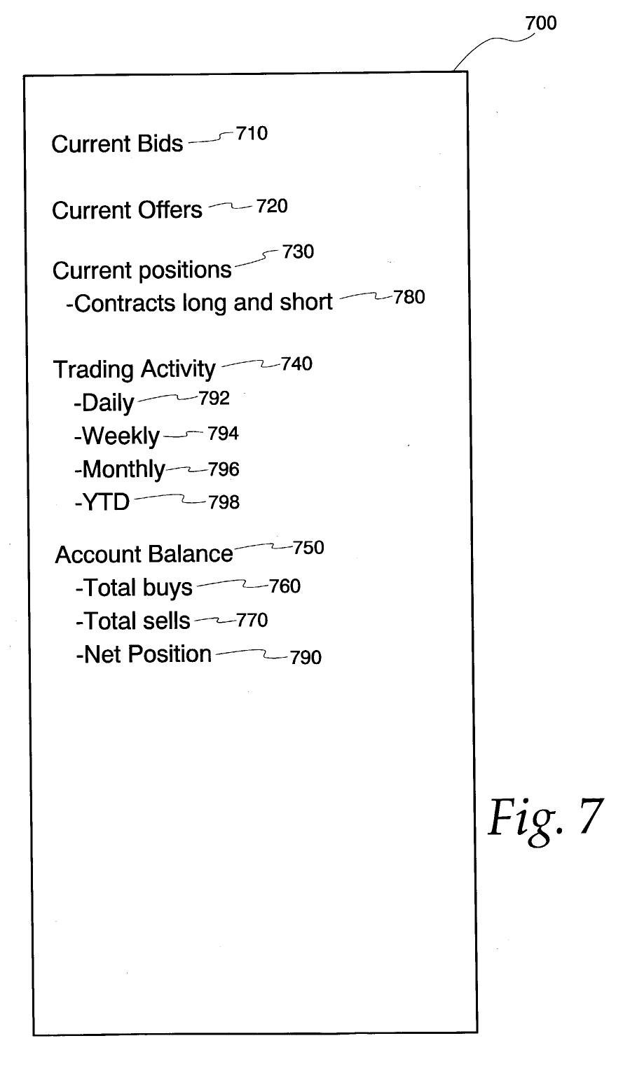

Referring to FIGS. 6 and 7, in an embodiment, the confirmed order will then be logged onto the order input entry input screen 600, via the data interface 140, and incorporated into appropriate columns of a current position screen 700. The current position screen 700 may be accessed from the current position 630 option of the order input entry screen 600. The current position screen 700 includes, but is not limited to, the following entries: current bids 710, current offers 720, current positions 730, trading activity 740 and account balance 750. A trader at computer system 180 can summon the current position data or other data received or stored by the data interface 140 onto the order input entry input screen 600 by, for example, scrolling to, activating by voice, or selecting via keyboard, touch screen mouse or other method the data requested. At such prompting the data will appear on the monitor 600 display and can be dragged to a location on the display the trader desires. Or the selected data can be part of a list on the display illustrating all of the commands for data that a trader has requested. These commands may be selected to display information on current positions 730, or current bids and/or offers 710 and 720, number of contracts bought or sold 760 and 770, outstanding contracts that are net long or net short 780, and net positions 790 as well as their current profit loss status. Total trading activity for the day 792, week 794, month 796 or year to date 798 can also be displayed at the request of a trader. The financial status of particular trades either on an historic or ongoing status for the day, week, month or year to date can also be displayed.

In an alternative embodiment, the virtual trading floor system 100 may be expanded to be a virtual reality trading floor system. The virtual reality trading floor system architecture is similar to the virtual trading floor system 100 shown in FIG. 1, except that the avatar interface 150 would be a virtual reality interface, requiring the user to utilize or wear goggles, a virtual reality headset, or other virtual reality equipment, and the data feed from the coder/decoder 120 would have to be compatible with a virtual reality interface. It is contemplated that the virtual reality trading system could be implemented by way of 3-D generated virtual reality images, virtual reality headsets or goggles, virtual reality gloves, or more sophisticated approaches such as wrap-around display screens, actual rooms augmented with wearable computers, and haptic joystick devices that allows a user to feel the display images, or any other virtual reality systems or equipment.

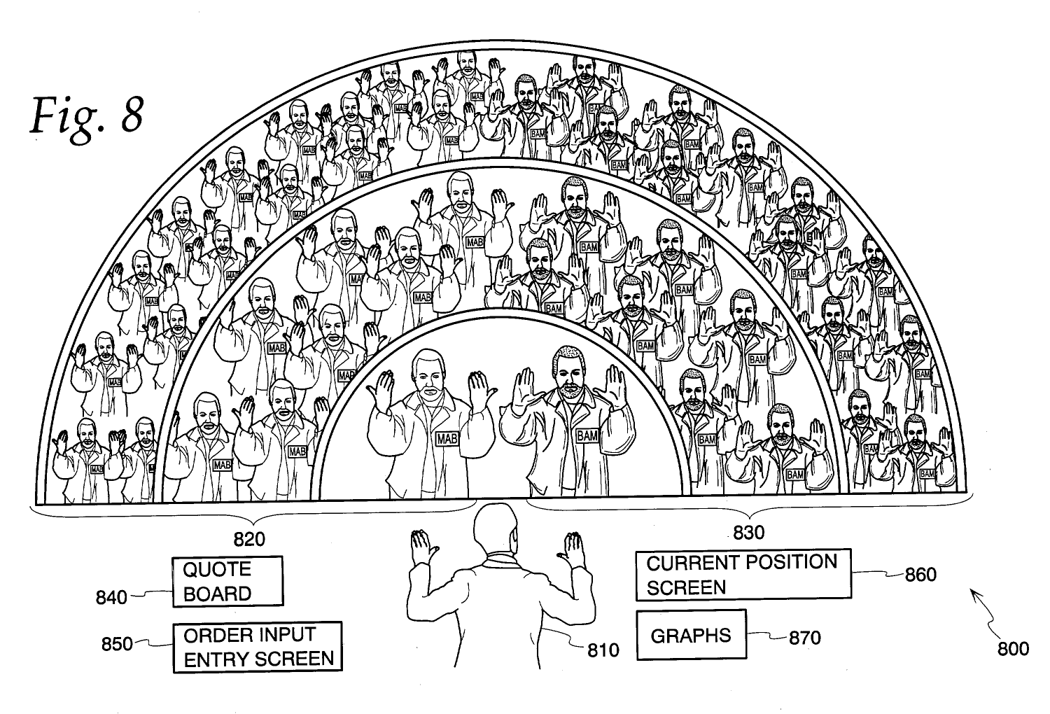

FIG. 8 represents the view by a participant 810 of a display in a virtual reality trading floor system according to an embodiment of the invention. Referring to FIG. 8, in the virtual reality trading floor system, a participant 810 operates and functions on a virtual reality trading floor 800. The participant 810 represents a trader at computer system 180. In the virtual reality trading floor system, the avatar interface 150 generates full-motion graphical metaphors that represent real persons in a cyberspace system. In the virtual reality trading floor embodiment, the avatar interface 150 would be capable of generating 3-dimensional metaphors whose movements, actions, size and shape are responsive to and synchronized with an actual trader's movements.

In the virtual reality trading floor system, the participant 810 views himself/herself as being on the virtual reality trading floor 800 and faces the opposing traders represented by buying trader metaphors 820 and selling trader metaphors 830 who are bidding and offering for the same commodity or stock. The same best bid and best offer display format, where the best bid and offer metaphors are in the forefront, used in the virtual trading floor system 100 may be incorporated. Alternatively, a randomly interspersed selection of bids and offers can be represented by the buying trader metaphors 820 and selling trader metaphors 830 obligating the participant 810 to find the best bid and offer among the crowd, as would be the case in a live auction. The best bid and offer among the opposing traders could be highlighted by having the buying trader metaphors 820 and selling trader metaphors 830 “pop up” throughout the crowd as prices change and the best bids and offers become represented by other opposing trader metaphors. If the participant 810 is the best bid or offer, the participant 810 will be highlighted to opposing traders in the crowd in the same manner that the participant 810 views the other buying 820 and selling trader metaphors 830 when they are highlighted.

Through virtual reality hardware, the participant 810 would enter the trading forum and be able to interact within a market with opposing traders. The display that comprises the virtual reality trading floor 800 could be as simple as a monitor, or as complex as a virtual reality viewer or an actual room augmented with wearable computers to create a full-blown virtual reality environment that would place the participant on the virtual reality trading floor 800. In the virtual reality trading floor system, orders would be initiated from the control interface 130, and made by, but not limited to, gestures and voice and/or keyboard, keypad or touch pad, and confirmed through the data interface 140. A virtual reality or cyberspace form of a quote board 840, order input entry screen 850, current position screen 860 and/or graphs 870 may comprise part of the virtual reality trading floor 800 display and may be easily viewed and accessed by the participant 810. An algorithm for trade matching, based on a prorated or FIFO trading match scheme could be incorporated. Each trader would view the market in the first person with the other traders arranged oppositionally in the trading crowd.

As the market volume grows, traders in the crowd depicted as buying trader metaphors 820 and selling trader metaphors 830 can each be assigned to represent more than one actual trader. If, for instance, only 100 traders can visually fit into the virtual reality trading floor 800 and 150 traders desire to trade, each trader metaphor may represent the actions of 15 actual traders. If 500 traders wanted to trade in a particular market, each of the 100 trader metaphors could represent 5 traders, and so on. Consequently, the virtual reality trading floor 800 will permit an unlimited number of participants to trade among one another to determine the best market price for a particular stock, commodity or the like. In an embodiment, the virtual trading floor system 100 may be interfaced with the virtual reality trading floor system to offer an option to participants who are not part of the virtual reality trading floor system so that they may interact in the simulated marketplace.

Additionally, both the virtual trading floor 100 and virtual reality trading floor systems may be implemented as a game that is played by one or more players physically located in the same location or remotely over a network, such as the Internet. When played over a network, individuals may be required to be paying subscribers. Market data would be randomly generated for different futures markets and the players may operate in various simulated trading floors. Players would add to or lose their stake depending on market direction and the player's market position. The game could have an option to increase activity and trading volume. Any number of input devices could be used to enter trades. These might include keyboard, mouse, or a virtual reality glove that would cause the player's movements to be mimicked on a display device to other traders. The display device could be as simple as a monitor, or as complex as a virtual reality viewer which would place the participant in a virtual trading floor. Visual color changes may highlight an opposing trader with the best bid or offer, or the player's badge might light up to help confirm trading action. On-screen wallboards or a simulated ticker could provide visual information on the market. Another indication of market action would be audio bids and offers being shouted with the volume level increasing or decreasing as a reflection of market activity. Traders could have the ability to control the pace and volume of the market ranging from slow, lightly traded markets, to a fast paced market with simulated shouting and visual cues bombarding the participant. The game could also be customized by product and for the trading practices of a particular exchange. The virtual trading floor or virtual reality trading floor systems could also be used as a training simulator.

General Purpose Computer Hardware Overview

FIG. 9 is a block diagram that illustrates a computer system 900 which may implement any one or more of the trading source 110, coder/decoder 120, avatar interface 150, data interface 140 or control interface 130. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912. The display may be comprised of, but is not limited to, one or more cathode ray tube (CRT) monitors or touch-screen devices, a projection screen or device, a display for generating virtual reality images, a wrap-around display screen, 3-D or virtual reality headsets or goggles, or an actual room augmented with wearable computers to create a fill-blown virtual reality environment. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for a virtual trading floor application. According to one embodiment of the invention, coder/decoder 120, and the control 130, data 140 and avatar interfaces 150 are implemented by one or more computer systems such as computer system 900 by executing one or more sequences of one or more instructions contained in main memory 906. Such instructions may be read into main memory 906 from another computer-readable medium, such as storage device 910. Execution of the sequences of instructions contained in main memory 906 causes processor 904 to perform the steps described herein. In alternative embodiments, hard-wired circuitry may be used in place of or in combination with software instructions to implement the invention. Thus, embodiments of the invention are not limited to any specific combination of hardware circuitry and software. For example, according to another embodiment, the coder/decoder 120 and the control 130, data 140 and avatar interfaces 150 could be embodied using one or more embedded single purpose computing devices.

The term “computer-readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. In accordance with the invention, one or more such downloaded applications may provide for generating 2-D and 3-D, graphic and non-graphic, displays or virtual reality displays as described herein.

The received code may be executed by processor 904 as it is received, and/or stored in storage device 910, or other non-volatile storage for later execution. In this manner, computer system 900 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A trading simulator, comprising:
a coder/decoder that receives and transmits data;
a graphic interface coupled to said coder/decoder, that receives and displays certain of said data transmitted from said coder/decoder as a plurality of buying and selling trader metaphors representative of actual buying and selling traders;
a control interface coupled to said coder/decoder for initiating orders related to said data received and transmitted by said coder/decoder; and
a data interface coupled to said coder/decoder for displaying said data in a non-graphic, human-readable form, and for receiving and transmitting data to and from said coder/decoder.

2. The trading simulator of claim 1, wherein said coder/decoder receives said data from a trading source.

3. The trading simulator of claim 1, wherein said graphic interface, said control interface and said data interface comprise a single interface.

4. The trading simulator of claim 1, wherein each said actual buying trader is represented by a human metaphor having a hand up and facing in toward said human metaphor.

5. The trading simulator of claim 1, wherein each said actual selling trader is represented by a human metaphor having a hand up that is facing out and away from said human metaphor.

6. The trading simulator of claim 1, wherein a particular one of said plurality of buying trader metaphors is positioned visually forward or is characterized by a larger metaphor than the remaining said plurality of buying trader metaphors, and is representative of one of said actual buying traders having the highest bid price for a security.

7. The trading simulator of claim 1, wherein a particular one of said plurality of selling trader metaphors is positioned visually forward or is characterized by a larger metaphor than the remaining said plurality of selling trader metaphors, and is representative of one of said actual selling traders having the lowest offer price for a security.

8. The trading simulator of claim 1, wherein each of said plurality of buying and selling trader metaphors has an associated visual price designation and an associated visual quantity designation.

9. The trading simulator of claim 1, wherein said plurality of selling trader metaphors are arranged in rows based on the offer price of each said selling trader, such that any selling trader in a first row will have an associated offer price that is below that of any selling trader in a second row which is behind said first row, and such that said plurality of selling trader metaphors are arranged within each row in order of offer price.

10. The trading simulator of claim 1, wherein said plurality of buying trader metaphors are arranged in rows based on the bid price of each said buying trader, such that any buying trader in a first row will have an associated bid price that is above that of any buying trader in a second row which is behind said first row, and such that said plurality of buying trader metaphors are arranged within each row in order of bid price.

11. The trading simulator of claim 1, wherein said plurality of selling trader metaphors are represented by a first color, and wherein said plurality of buying trader metaphors are represented by a second color.

12. The trading simulator of claim 1, wherein a given one of said plurality of selling trader metaphors representative of a best offer price is adjacent to a given one of said plurality of buying trader metaphors representative of a best bid price.

13. The trading simulator of claim 1, further comprising an auditory means for providing price and quantity designations associated with a particular buying or selling trader.

14. The trading simulator of claim 1, wherein a particular one of said plurality of buying trader metaphors is representative of a plurality of said actual buying traders each having the highest bid price for a security.

15. The trading simulator of claim 1, wherein a particular one of said plurality of selling trader metaphors is representative of a plurality of actual selling traders each having the lowest offer price for a security.

16. The trading simulator of claim 1, wherein a particular one of said plurality of buying trader metaphors is representative of a plurality of said actual buying traders.

17. The trading simulator of claim 1, wherein a particular one of said plurality of selling trader metaphors is representative of a plurality of said actual selling traders.

18. The trading simulator of claim 1, wherein a particular one of said plurality of buying trader metaphors is representative of a plurality of said actual buying traders and has an associated visual price designation and an associated visual quantity designation.

19. The trading simulator of claim 1, wherein a particular one of said plurality of selling trader metaphors is representative of a plurality of said actual selling traders and has an associated visual price designation and an associated visual quantity designation.

20. The trading simulator of claim 1, wherein the number of said plurality of buying and selling trader metaphors changes correspondingly to said number of said actual buying and selling traders trading in a particular security.

21. The trading simulator of claim 1, further comprising an auditory means whose volume fluctuates correspondingly to said number of said actual buying or selling traders trading in a particular security.

22. The trading simulator of claim 1, further comprising an auditory means whose volume fluctuates correspondingly to said number of said actual buying or selling traders trading in a particular market.

23. The trading simulator of claim 1, further comprising an auditory means from which the audio fluctuates correspondingly to said number of said actual buying or selling traders trading in a plurality of markets.

24. The trading simulator of claim 1, further comprising an auditory means for providing the confirmation of a trade between a particular one of said actual buying traders and a particular one of said actual selling traders.

25. The trading simulator of claim 1, further comprising an auditory means from which the audio fluctuates correspondingly with the volume of trading in a particular security.

26. The trading simulator of claim 1, further comprising an auditory means from which the audio fluctuates correspondingly with the volume of trading in a particular market.

27. The trading simulator of claim 1, further comprising an auditory means from which the audio fluctuates correspondingly with the volume of trading in a plurality of markets.

28. The trading simulator of claim 1, further comprising a quote board displayed with said plurality of buying and selling trader metaphors.

29. The trading simulator of claim 1, wherein said plurality of buying and selling trader metaphors are representative of actual selling and buying traders in different markets, and are displayed on different segments of a given display.

30. The trading simulator of claim 29, wherein a trader may place orders in a given market of said different markets that has been designated as active.

31. The trading simulator of claim 1, further comprising a displayed quote board containing information from one or more different markets.

32. The trading simulator of claim 31, wherein a trader may place orders in a given market of said different markets that is visually designated as active in said quote board, and where said plurality of buying and selling metaphors are representative of activity in said given market.

33. The trading simulator of claim 31, wherein a trader may place orders in a given market of said different markets that is visually designated as active in said quote board, and where said plurality of buying and selling metaphors are representative of activity in a different market.

34. A trading simulator, comprising:
a source that provides data; and
a graphical interface that receives said data and displays a plurality of buying and selling trader metaphors representative of actual buying and selling traders.

35. A trading simulator, comprising:
a source that generates data;
a coder/decoder coupled to said source, said coder/decoder receiving said data from said source; and
a graphical interface that receives said data from said coder/decoder and displays a plurality of buying and selling trader metaphors representative of actual buying and selling traders.

36. A trading simulator, comprising:
a source that generates data;
a coder/decoder coupled to said source;
a graphic interface coupled to said coder/decoder;
a control interface coupled to said coder/decoder; and
a data interface coupled to said coder/decoder.

37. A trading simulator, comprising:
a coder/decoder that transmits and receives data;
a control interface coupled to said coder/decoder;
a data interface coupled to said coder/decoder; and
a graphical interface coupled to said coder/decoder for receiving said data from said coder/decoder and for displaying a plurality of buying and selling trader metaphors representative of actual buying and selling traders, wherein the movement of at least one of said buying and selling metaphors is responsive to and synchronized with an actual trader's movements.

38. A trading simulator, comprising:
a source that generates data;
a coder/decoder coupled to said source;
a control interface coupled to said coder/decoder;
a data interface coupled to said coder/decoder; and
a graphical interface coupled to said coder/decoder for receiving said data from said coder/decoder and for displaying a plurality of buying and selling trader metaphors representative of actual buying and selling traders, wherein the movement of at least one of said buying and selling metaphors is responsive to and synchronized with an actual trader's movements.

39. The trading simulator of claim 38, wherein said at least one of said buying and selling trader metaphors visually faces the remaining ones of said buying and selling trader metaphors.

40. A method of trading using a trading simulator, comprising the steps of:
generating data;
receiving said data; and
displaying said data in the form of a plurality of buying and selling trader metaphors representative of actual buying and selling traders.
